(19) United States
(12) Patent Application Publication
(10) Pub. No.: US 2010/0000226 A1
(43) Pub. Date: Jan. 7, 2010

(54) TURBOFAN ENGINE WITH AT LEAST ONE APPARATUS FOR DRIVING AT LEAST ONE GENERATOR

(75) Inventor: Detlef Rensch, Ludwigsfelde (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/498,120

(22) Filed: Jul. 6, 2009

(30) Foreign Application Priority Data
Jul. 3, 2008 (DE) 10 2008 031 185.5

(51) Int. Cl. F02C 6/04; F02G 3/00; H02K 7/18

(52) U.S. Cl. 60/784; 60/39.15; 290/1 A

(57) ABSTRACT

A turbofan engine (1) includes at least one apparatus (30) for driving at least one generator (22, 35), with the engine including a pre-compressor (4), at least one compressor (10) and at least two engine shafts (13, 15) rotatably arranged in an engine casing. At least one first generator (22) is coupled via an auxiliary gearbox (21) with one of the engine shafts (13) and is electrically connected to at least one accessory (23). In order to generate electrical power to such an amount in a turbofan engine (1) that stable operation of the accessories (23), in particular the compressors, is maintained also in the low-energy range, the apparatus (30) includes at least one auxiliary turbine (31) arranged between the pre-compressor (4) and the compressor (10).

This application claims priority to German Patent Application DE102008031185.5 filed Jul. 3, 2008, the entirety of which is incorporated by reference herein.

This invention relates to a turbofan engine with at least one apparatus for driving at least one generator and an application of the turbofan engine. Furthermore, the present invention relates to a method for driving at least one generator of the turbofan engine.

State of the art is the present-day two-shaft turbofan engine which is equipped with a pre-compressor. This engine category is increasingly used for the propulsion of aircraft having an increased demand for electrical power (“more electric aircraft”). This increased demand occurs because, for example, the cabin is not supplied with air from the compressor of the turbofan engine as on conventional aircraft, but from electrically operated compressors. This entails more powerful generators and, consequently, increased loading of the turbofan engine. On the two-shaft turbofan engine, this load is extracted from the high-pressure shaft.

The major disadvantage of this development is that, in the attempt to provide an improved product on aircraft level, the turbofan engine is under certain operating conditions confronted with aggravated boundary conditions, in particular with respect to stability. This shows in problems in maintaining the operation of the high-pressure compressor stable.

Basically, in order to save fuel, it is attempted to operate the turbofan engine at minimum effort, accordingly running it, under conditions requiring low thrust, at lowest possible speed. In some operating cases, further boundary conditions become relevant, for example the cabin pressure limit. The cabin pressure limit is the minimum pressure the turbofan engine is required to supply for cabin pressurization.

If the compressed air is however no longer supplied by the compressor of the turbofan engine, but by electrically operated compressors in the aircraft, the cabin pressure limit becomes irrelevant, enabling the turbofan engine to be run at lower speed in certain operating cases.

Provision is thus made that the turbofan engine is just kept running when operating under low-power conditions, such as descent or ground idle, and consequently also consumes less fuel. However with the additional load being high in relation to the total power, the stability of the compressor of the turbofan engine is made more difficult to control, i.e. the margin between the working line and the surge limit decreases.

The current two-shaft turbofan engine includes a high-pressure and a low-pressure shaft. The high-pressure shaft drives the auxiliary gearbox to which various accessories, including the generators providing the electrical power, are attached. A high-pressure system is accordingly provided which includes the high-pressure shaft and the auxiliary gearbox. From there, the entire power required for driving the accessories on the auxiliary gearbox is extracted, in particular for the generators which, in turn, supply the electrical power for, among others, the compressors delivering the cabin air. This entails that, in relation to the total energy content, a relatively high amount of energy is extracted from the high-pressure shaft under low-energy conditions. Thus, with the load on the high-pressure shaft impairing the surge margin, compressor stability is negatively affected.

Specification US 2005/0056021 A1 describes a multi-shaft turbogenerator in which a main generator is driven by the shaft of the high-pressure train and an auxiliary generator/motor is driven by the shaft of the low-pressure train, or vice versa. Disadvantageous here is the additional power loss at the low-pressure train and in the appertaining gearbox.

As an alternative, it is disclosed that the main generator or the auxiliary generator are driven by the exhaust gas from the gas turbine propelling an auxiliary turbine whose shaft is coupled with the auxiliary generator or the main generator. Disadvantageous here is that the auxiliary turbine is exposed to the high temperatures of the gas flow exiting from the gas turbine and, further, the auxiliary turbine is subject to qualification requirements.

Furthermore, a system is disclosed in which the auxiliary generator/motor is driven by a shaft of the gas turbine. The main generator is driven by an additional combustion engine. Disadvantageous here is the extra constructional investment and weight for the additional combustion engine.

In Specification WO 2006/060014 A1, a starter-generator system for a turbine drive is described in which a rotor is arranged around a stator and the rotor is firmly connected to the compressor rotor. When used as motor (starter), the system receives electrical power from an external power source. When the turbine drive is at operating speed, the system is operated as generator supplying various devices with electrical power. The system is disadvantageous in that it has high weight.

A broad aspect of the present invention therefore is to generate electrical power in a turbofan engine to such an amount that stable operation of the accessories, in particular the compressors, is maintained also in the low-energy range.

It is a particular object of the present invention to provide a turbofan engine with at least one apparatus for driving at least one generator, with the engine including a pre-compressor, at least one compressor and at least two engine shafts rotatably arranged in an engine casing. At least one first generator is coupled via an auxiliary gearbox with one of the engine shafts and is electrically connected to at least one accessory. The apparatus includes at least one auxiliary turbine arranged between the pre-compressor and the compressor.

The auxiliary turbine serves to extract energy from the airflow compressed by the pre-compressor, thereby supplying energy from the outside into the high-pressure system to relieve the high-pressure shaft. This energy is extracted from the pre-compressor airflow independently of the core engine and converted into electrical power by means of a generator. This additional power can then be fed into the onboard system, with the effect that the energy take-off from the high-pressure shaft is correspondingly reduced and the high-pressure shaft is relieved.

Thus, a simple solution for relieving the high-pressure shaft is provided. Energy is here transferred from the low-pressure system into the high-pressure system.

Furthermore, use is made of the space between the pre-compressor and the compressor. At this location, the operating temperature is relatively low so that overheating of the auxiliary turbine is avoided.

The auxiliary turbine can be coupled with at least one second generator, which is independent of the engine shafts. The independent second generator enables electrical power to be produced even in the event of a failure of the first generator. Otherwise, both generators supply electrical power, enabling a temporarily increased power demand to be covered.

The auxiliary turbine extracts energy from the compressed air. This results in a reduction of the temperature of the air, with positive effects on the high-pressure compressor inlet temperature as well as the selection of the materials and the weight of the high-pressure compressor.

In an alternative embodiment, the auxiliary turbine can be coupled, via the auxiliary gearbox, with the first generator which is connected to one of the engine shafts. In this embodiment, an additional generator is not required. Furthermore, energy can continuously be fed into the high-pressure system. Additional design modifications of the turbofan engine are not required.

In a preferred embodiment, the auxiliary turbine, independently of the engine shafts, is rotatable around at least one of the engine shafts. This arrangement is particularly suitable for utilizing the energy of the airflow exiting from the pre-compressor. The independent rotation of the auxiliary turbine enables the generators to be safely operated, independently of the core engine, even under low-energy conditions.

More particularly, the auxiliary turbine can be coupled via at least one gear arrangement with the auxiliary gearbox, which is connected to the first generator, and/or with the second generator. Thus, the auxiliary turbine is operationally flexible. The auxiliary turbine drives either the first generator or the second generator or both of them.

Preferably, a first clutch is provided between the gear arrangement and the auxiliary gearbox coupled with the first generator. Additionally, a second clutch between the gear arrangement and the second generator or a separable electric connection between the second generator and the accessory can be provided. The clutches or the separable electric connection, respectively, enable the auxiliary turbine to be decoupled when the demand for electrical power falls, for example at high speed of the high-pressure shaft. The clutch can be a free-wheeling device or a fluid clutch, for example.

The auxiliary turbine can be borne on one of the engine shafts. This type of bearing is space and weight-saving.

Alternatively, the auxiliary turbine can be borne in the engine casing. This embodiment provides for ease of assembly.

Preferably, the turbofan engine is used in a more-electric aircraft with electrically operated compressors or any other increased demand for electrical power. On this type of aircraft, the generator-driven compressors entail a particularly high demand for electrical power. This power demand can reliably be covered with the turbofan engine according to the present invention.

It is a further aspect of the present invention to provide a method for the operation of the at least one generator of the turbofan engine. The auxiliary turbine converts flow energy from the pre-compressor airflow exiting from the pre-compressor into rotational energy, with the latter driving, if required, the at least one generator supplying the accessory with electrical power.

Accordingly, this method uses the flow energy produced by the pre-compressor to drive the second generator and/or—via the auxiliary gearbox—the first generator, thereby supplying the accessories with electrical power. This energy is therefore saved on the core engine, i.e. the high-pressure shaft is relieved and fuel consumption of the turbofan engine is lowered.

In particular, the auxiliary turbine transfers the rotational energy to the gear arrangement, thereby driving the second generator, additionally to the high-pressure shaft driving the first generator, and/or—via the auxiliary gearbox—the first generator if the electrical power required is higher than the electrical power produced on the first generator by rotation of the engine shaft.

This operating state occurs at low-energy conditions (e.g. descent, ground idle operation). The method ensures that in this operating state, with the high-pressure shaft producing low energy, the auxiliary turbine drives at least one generator, thus compensating for the energy loss.

The gear arrangement of the auxiliary turbine is coupled with the auxiliary gearbox with the first generator by the first clutch. Furthermore, the gear arrangement of the auxiliary turbine can be coupled with the second generator by the second clutch or the second generator electrically connected to the accessory. This enables energy to be transferred from the auxiliary turbine to the first and/or the second generator under low-energy conditions.

Preferably, the auxiliary turbine rotates, relative to the engine shaft coupled with the first generator, in a speed range suitable for generator operation. The speed range is defined by the applicable requirement on the generator. The auxiliary turbine is here designed such that it rotates, relative to the high-pressure shaft, within the usual speed range of the first generator.

Furthermore, the auxiliary turbine rotates freely around the at least one turbine shaft if the electrical power produced at the first generator by rotation of the engine shaft is sufficient. This method applies to operating states with high rotational speed of the high-pressure shaft. The energy produced on the first generator by the high-pressure shaft is here sufficient for supplying all accessories, in particular the compressors with electrical power.

The gear arrangement of the auxiliary turbine can be decoupled from the auxiliary gearbox with the first generator by the first clutch. Furthermore, the gear arrangement of the auxiliary turbine can be decoupled from the second generator by the second clutch or the second generator electrically disconnected from the accessory. Thus, the generation of surplus electrical power can be avoided in operating states with high energy in the high-pressure system.

In the following, two examples of the present invention are more fully described in light of the accompanying two Figures:

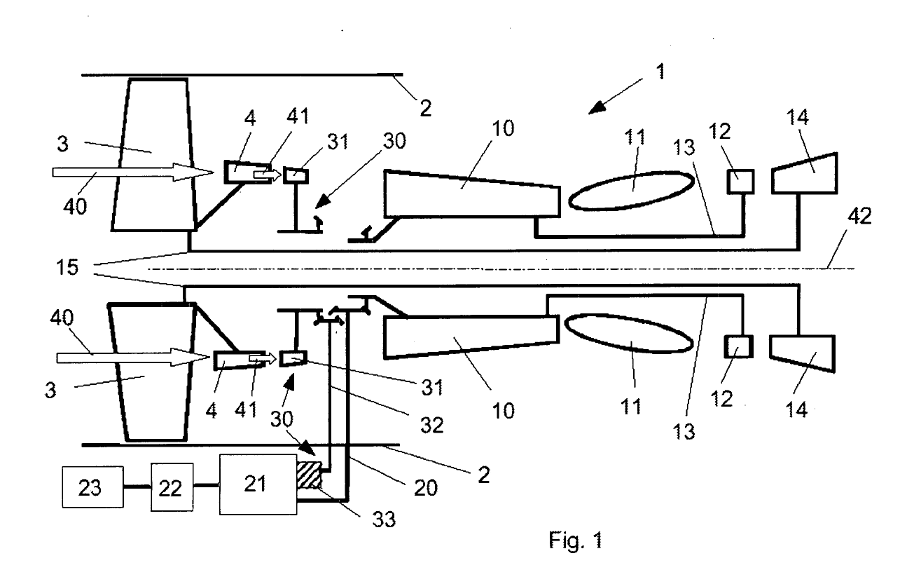

FIG. 1 is a schematic representation of a first embodiment of the present invention with only one generator, and

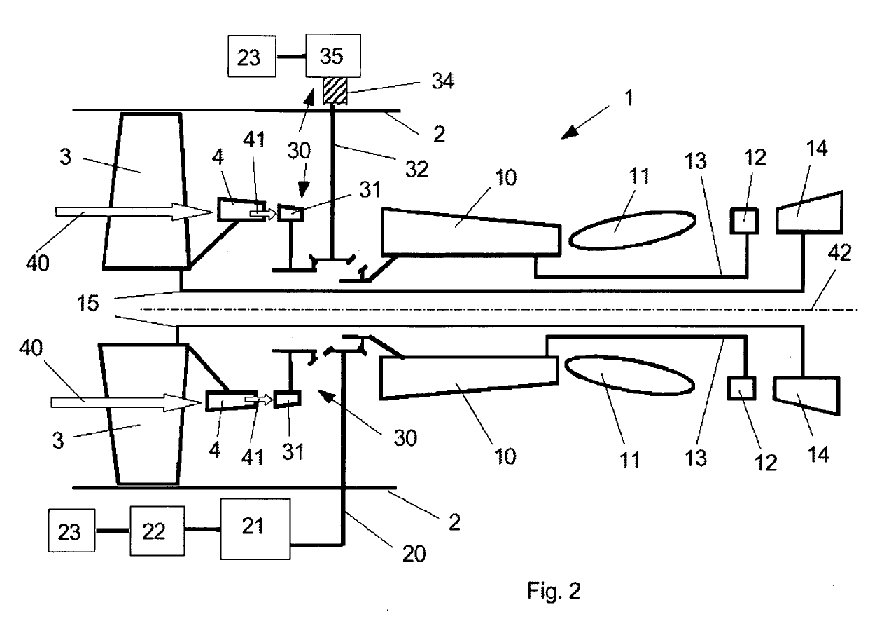

FIG. 2 is a schematic representation of a second embodiment with a first and a second generator.

FIGS. 1 and 2 each schematically show a turbofan engine 1 with a fan casing 2, a fan 3 and a pre-compressor 4. Furthermore, the turbofan engine 1 includes a compressor 10, a combustion chamber 11, a high-pressure turbine 12, a high-pressure shaft 13 (engine shaft), a low-pressure turbine 14 and a low-pressure shaft 15 (engine shaft). Also, the turbofan engine 1 has a radial shaft 20, an auxiliary gearbox 21, a first generator 22, accessories 23 and an apparatus 30.

In the turbofan engine 1, the fan casing 2, the fan 3, the pre-compressor 4, the compressor 10, the combustion chamber 11, the high-pressure turbine 12 and the low-pressure turbine 14 are arranged behind each other in the flow direction and rotationally-symmetrically around the high-pressure shaft 13 and the low-pressure shaft 15 and, thus, the centerline 42. The fan casing 2 encloses the fan 3 and the pre-compressor 4.

The radial shaft 20 connects the high-pressure shaft 13 to the auxiliary gearbox 21. The auxiliary gearbox 21 is coupled with the accessories 23 via the first generator 22.

FIG. 1 schematically shows the first embodiment of the turbofan engine 1 with the apparatus 30. The apparatus 30 includes an auxiliary turbine 31, a gear arrangement 32, and a first clutch 33.

The auxiliary turbine 31 is set up rotationally-symmetrically to the centerline 42 and disposed between the pre-compressor 4 and the compressor 10. The auxiliary turbine 31 is borne on the low-pressure shaft 15 and coupled with the first generator 21 via the gear arrangement 32 and the first clutch 33.

In operation, the fan 3 produces a fan airflow 40 which enters the pre-compressor 4. The pre-compressor 4, in turn, produces a pre-compressor airflow 41 which enters the auxiliary turbine 31 to drive the latter. In the process, the auxiliary turbine 31 produces rotational energy which is transferred to the gear arrangement 32.

The auxiliary turbine 31 drives, via the gear arrangement 32 and a shaft—not illustrated—the auxiliary gearbox 21. The first clutch 33 between the gear arrangement 32 and the auxiliary gearbox 21 ensures that power is transmitted always into the auxiliary gearbox 21 only. The first clutch 33 can operate either mechanically or by a fluid.

Via a—not illustrated—gear train in the auxiliary gearbox 21, the first generator 22 and any other—not illustrated—generators are then driven, thereby producing energy to supply the accessories 23 with electrical power.

Therefore, the driving power for the auxiliary gearbox 21 is not extracted one hundred percent from the high-pressure shaft 13, but also from the low-pressure shaft 15 via the air compressed by the fan 3 and the pre-compressor 4. Thus, the high-pressure shaft 13 is relieved and, consequently, its operational stability correspondingly improved.

FIG. 2 schematically shows the second embodiment of the turbojet engine 1 with the apparatus 30. The apparatus 30 includes an auxiliary turbine 31, a gear arrangement 32, a second clutch 34, a second generator 35 and the accessories 23.

The auxiliary turbine 31 is set up rotationally-symmetrically to the centerline 42 and disposed between the pre-compressor 4 and the compressor 10. The auxiliary turbine 31 is borne on the low-pressure shaft 15 and coupled with the second generator 35 via the gear arrangement 32 and the second clutch 34. The second generator 35 is connected to the same accessories 23 as the first generator 22.

In operation, the fan 3 produces a fan airflow 40 which enters the pre-compressor 4. The pre-compressor 4, in turn, produces a pre-compressor airflow 41 which enters the auxiliary turbine 31 to drive the latter. In the process, the auxiliary turbine 31 produces rotational energy which is transferred to the gear arrangement 32.

The auxiliary turbine 31 drives, via the gear arrangement 32 and a—not illustrated—shaft, the second generator 35 which produces energy suitable for supplying the accessories 23 with electrical power.

The second generator 35, in terms of its input speed, has a limited operating range only. Therefore, the second generator 35 must be operated such that it supplies electrical power in the critical cases, i.e. under low-energy conditions, and is electrically disconnected in the non-critical cases, i.e. in operating ranges with high load.

Alternatively, the gear arrangement 32 can be decoupled from the second generator 35 by the second clutch 34. The second clutch can be a mechanical free-wheeling device or a fluid clutch, for example.

### LIST OF REFERENCE NUMERALS

1 Turbofan engine

2 Fan casing

3 Fan

4 Pre-compressor

10 Compressor

11 Combustion chamber

12 High-pressure turbine

13 High-pressure shaft

14 Low-pressure turbine

15 Low-pressure shaft

20 Radial shaft

21 Auxiliary gearbox

22 First generator

23 Accessories

30 Apparatus

31 Auxiliary turbine

32 Gear arrangement

33 First clutch

34 Second clutch

35 Second generator

40 Fan airflow

41 Pre-compressor airflow

42 Centerline

What is claimed is:

1. A turbofan engine, comprising:
an engine casing;
a pre-compressor;
at least one compressor;
at least two engine shafts rotatably arranged in the engine casing;
an auxiliary gearbox;
at least one first generator being coupled via the auxiliary gearbox with one of the engine shafts and being electrically connected to at least one accessory;
at least one apparatus for driving the at least one first generator, the apparatus including at least one auxiliary turbine connected between the pre-compressor and the compressor.

2. The turbofan engine of claim 1, and further comprising at least one second generator which is independent of the two engine shafts, to which the auxiliary turbine can be coupled.

3. The turbofan engine of claim 1, wherein the auxiliary turbine can be coupled, via the auxiliary gearbox, with the first generator.

4. The turbofan engine of claim 1, wherein the auxiliary turbine, independently of the engine shafts, is rotatable around at least one of the engine shafts.

5. The turbofan engine of claim 3, and further comprising at least one gear arrangement by which the auxiliary turbine can be coupled with the auxiliary gearbox.

6. The turbofan engine of claim 5, and further comprising a first clutch operatively positioned between the gear arrangement and the auxiliary gearbox.

7. The turbofan engine of claim 6, and further comprising a second generator and a second clutch operatively positioned between the gear arrangement and the second generator.

8. The turbofan engine of claim 1, wherein the auxiliary turbine is borne on one of the engine shafts.

9. The turbofan engine of claim 1, wherein the auxiliary turbine is borne in the engine casing.

10. A method for driving at least one generator of a turbofan engine, comprising:
providing a pre-compressor;
providing a compressor;
providing an auxiliary turbine positioned downstream of the pre-compressor and upstream of the compressor;
driving the auxiliary turbine with an airflow from the pre-compressor to convert flow energy from the pre-compressor airflow exiting from the pre-compressor into rotational energy for driving at least one first generator.

11. The method of claim 11, and further comprising:
transferring rotational energy from the auxiliary turbine to a second generator via a gear arrangement, thereby driving the second generator, and
also transferring rotational energy from the auxiliary turbine to the at least one first generator via to a high-pressure shaft driving the first generator, and via an auxiliary gearbox, if an electrical power required from the at least one first generator is higher than produced on the at least one first generator by rotation of the engine shaft.

12. The method of claim 12, and further comprising coupling the auxiliary turbine with the auxiliary gear box via a gear arrangement and a first clutch.

13. The method of claim 12, and further comprising coupling the auxiliary turbine with the second generator via the gear arrangement and a second clutch.

14. The method of claim 10, and further comprising rotating the auxiliary turbine, relative to the engine shaft coupled with the first generator, in a speed range suitable for generator operation.

15. The method of claim 13, and further comprising allowing the auxiliary turbine to rotate freely around the at least one turbine shaft if the electrical power produced at the first generator by rotation of the engine shaft is sufficient.

16. The method of claim 15, and further comprising decoupling the gear arrangement from the auxiliary gearbox with the first clutch.

17. The method of claim 16, and further comprising at least one of: decoupling the gear arrangement from the second generator with the second clutch, and electrically disconnecting the second generator from an electrical accessory.
